(19) United States
(12) Patent Application Publication
(10) Pub. No.: US 2013/0089356 A1
(43) Pub. Date: Apr. 11, 2013

(54) IMAGE FORMING APPARATUS

(71) Applicants: Hideo YAMAKI, Tokyo (JP); Satoshi NISHIDA, Saitama-shi (JP)

(72) Inventors: Hideo YAMAKI, Tokyo (JP); Satoshi NISHIDA, Saitama-shi (JP)

(73) Assignee: KONICA MINOLTA BUSINESS TECHNOLOGIES, INC., Tokyo (JP)

(21) Appl. No.: 13/614,159

(22) Filed: Sep. 13, 2012

(30) Foreign Application Priority Data
Oct. 6, 2011 (JP) 2011-221505

(51) Int. Cl. G03G 15/16

(52) U.S. Cl. 399/101

(57) ABSTRACT

An image forming apparatus includes: image carriers, an intermediate transfer body, primary transfer members, support members, a secondary transfer unit, a cleaning member, an adjustment mechanism, and a control unit. The support members rotatably support the intermediate transfer body. The cleaning member abuts against the intermediate transfer body at a position other than a position opposite to the support member under a predetermined condition based on a reference tension of the intermediate transfer body. The adjustment mechanism can adjust an abutment condition between the cleaning member and the intermediate transfer body. The control unit controls the adjustment mechanism to adjust the abutment condition to be suitable for removing, by the cleaning member, recording materials remaining on the intermediate transfer body without being transferred onto the transfer material when a tension of the intermediate transfer body is changed from the reference tension.

### BACKGROUND OF THE INVENTION

1. Field of the Invention

The present invention relates to an image forming apparatus including a cleaning unit that removes a recording material, which remains on an intermediate transfer body without being secondarily transferred onto a transfer material, in an event of primarily transferring images onto the intermediate transfer body individually in a plurality of primary transfer units, and further, secondarily transferring the images on the intermediate transfer body onto the transfer material in a secondary transfer unit.

2. Description of Related Art

An image forming apparatus has been known, which is capable of forming a full-color toner image on a transfer material in such a manner that toner images, which are obtained by performing color separation for a desired image and are different in color from one another, are primarily transferred onto an intermediate transfer body in a plurality of primary transfer units so as to be superimposed on one another, and that the superimposed toner images thus primarily transferred are secondarily transferred onto a transfer material.

In the image forming apparatus as described above, as shown in FIG. 13A, photosensitive drums 41Y to 41K, on which images of respective colors of yellow, magenta, cyan and black are to be formed, and primary transfer rollers 46Y to 46K for transferring the toner images on the photosensitive drums onto an intermediate transfer belt 31 are brought into pressure contact with each other through the intermediate transfer belt concerned, and an appropriate voltage is applied individually to the primary transfer rollers 46Y to 46K, whereby the toner images are electrostatically transferred from the photosensitive drums onto the intermediate transfer belt 31.

Moreover, in the image forming apparatus as described above, it is frequent to adopt a configuration, in which the photosensitive drums and the primary transfer rollers, which are brought into pressure contact with each other in the case where the primary transfer of the toner images is performed, are spaced apart from each other in the case where the primary transfer of the image of the color corresponding thereto is not performed.

For example, in the event of forming a monochrome image, the primary transfer of only the toner image of the black color is performed, and accordingly, as shown in FIG. 13B, the photosensitive drum 41K and the primary transfer roller 46K, which correspond to the black color, are in a pressure contact state with each other, and meanwhile, the photosensitive drums and the primary transfer rollers, which correspond to the colors other than the black color, are all in a state of being spaced from each other.

The images primarily transferred onto the intermediate transfer belt 31 are secondarily transferred onto the transfer material, which is conveyed to a secondary transfer unit, in the secondary transfer unit concerned. Here, a recording material that remains on the intermediate transfer belt without being completely transferred onto the transfer material in the secondary transfer unit is removed by a cleaning unit provided on a downstream side of the secondary transfer unit in a traveling direction of the intermediate transfer belt.

As a configuration of this cleaning unit, a configuration as shown in FIGS. 13A and 13B is widely known, in which a blade-like cleaning member 35a is allowed to abut against the intermediate transfer belt 31, whereby toners which have adhered onto the intermediate transfer belt 31 are scraped off. The above-described cleaning member 35a is allowed to abut against the intermediate transfer belt 31 at predetermined pressure and angle, which are suitable for the cleaning of the toners.

Moreover, in order to further enhance cleaning performance, it is preferable that the above-described cleaning member 35a be provided at a position that is not opposite to any of rollers which rotatably support the intermediate transfer belt 31.

This is because, if the cleaning member 35a is provided at a position opposite to the roller, then for example, in the case where some foreign object adheres onto the roller, it is apprehended that, as the roller rotates, the cleaning member 35a may behave like floating up following the foreign object concerned. When the cleaning member 35a behaves as described above, a gap occurs between the cleaning member 35a and the intermediate transfer belt 31, and the toners slip through the gap, thereby causing a problem that the cleaning performance is lowered, and this is not preferable.

In Japanese Patent Laid-Open Publication No. 2006-72254, an image forming apparatus is described, which is capable of performing good cleaning by constantly keeping a relative positional relationship between the intermediate transfer body and a cleaning unit even if a moving route of the intermediate transfer body is changed.

However, in the image forming apparatus described in Japanese Patent Laid-Open Publication No. 2006-72254, a change occurs in a tension of the intermediate transfer belt owing to a mode change of image formation, whereby an abutment relationship between the cleaning member and the intermediate transfer belt is changed, whereby the cleaning performance is sometimes lowered to affect the image formation that follows.

Specifically, as shown in FIG. 13A, in the event of forming a color image, the photosensitive drums 41Y to 41K and the primary transfer rollers 46Y to 46K, which correspond to the respective colors, are all in a pressure contact state with each other, and accordingly, the intermediate transfer belt 31 is pushed out in a direction (right direction in FIG. 13A) toward the photosensitive drums. In such a way, the tension of the intermediate transfer belt 31 is increased, whereby better cleaning is performed by the cleaning member 35a.

Meanwhile, in the event of forming the monochrome image by a similar image forming apparatus, as shown in FIG. 13B, the photosensitive drums and the primary transfer rollers, which correspond to the colors other than the black color, are all in a state of being spaced apart from each other. Accordingly, in comparison with the case of forming the color image, force with which the intermediate transfer belt 31 is pushed out in a direction toward the photosensitive drum is reduced. Hence, the tension of the intermediate transfer belt 31 is reduced in comparison with the case of forming the color image.

When the tension of the intermediate transfer belt is reduced, in the case where the cleaning member is provided at the position that is not opposite to the roller that supports the intermediate transfer belt, there has been a problem that such a phenomenon that the recording material slips through the cleaning member becomes prone to occur owing to slack of the intermediate transfer belt, and the image formation that follows is affected.

### SUMMARY OF THE INVENTION

The present invention has been made in consideration of the foregoing problems. It is an object of the present invention to provide an image forming apparatus capable of performing good image formation without causing a cleaning failure even if the tension of the intermediate transfer belt is changed owing to the change of the image formation mode, and the like.

According to an aspect of the present invention, there is provided an image forming apparatus comprising: a plurality of image carriers on which images are to be individually formed by recording materials; an intermediate transfer body onto which the images formed on the plurality of image carriers are to be transferred; a plurality of primary transfer members which individually transfer the images formed on the plurality of image carriers onto the intermediate transfer body; a support member that supports the intermediate transfer body; a secondary transfer unit that further transfers the images transferred onto the intermediate transfer body onto a transfer material; a cleaning member that abuts against the intermediate transfer body at a position other than a position opposite to the support member under a predetermined condition based on a reference tension of the intermediate transfer body, and removes the recording materials remaining on the intermediate transfer body without being transferred onto the transfer material in the secondary transfer unit; an adjustment mechanism capable of adjusting an abutment condition between the cleaning member and the intermediate transfer body; and a control unit that controls the adjustment mechanism to adjust the abutment condition between the cleaning member and the intermediate transfer body to become a condition suitable for removing the recording materials by the cleaning member in a case where a tension of the intermediate transfer body is changed from the reference tension of the intermediate transfer body.

Preferably, the image forming apparatus further comprising: pressure-contacting/leaving mechanisms which individually bring the plurality of primary transfer members into pressure contact with the plurality of image carriers and individually space the plurality of primary transfer members apart from the plurality of image carriers, wherein the control unit controls the pressure-contacting/leaving mechanisms to space the image carrier on which the image is not to be formed and the transfer member apart from each other, and controls the adjustment mechanism to adjust the abutment condition in a case where one or more of the image carriers and one or more of the transfer members are spaced apart from each other.

Preferably, the image forming apparatus further comprising: a color mode of forming a color image by forming images of colors different from one another on the plurality of image carriers by the recording materials of colors different from one another, and by superimposing the images of the colors different from one another on one another; a monochrome mode of forming a monochrome image as an image composed of a single color by the recording material of the single color on any one of the plurality of image carriers; and pressure-contacting/leaving mechanisms which individually bring the plurality of transfer members into pressure contact with the plurality of image carriers and individually space the plurality of transfer members apart from the plurality of image carriers, wherein the control unit controls the pressure-contacting/leaving mechanisms to space the image carrier on which the image is not to be formed and the transfer member apart from each other, and controls the adjustment mechanism to adjust the abutment condition in a case of executing the monochrome mode.

Preferably, the single color is black.

Preferably, the image forming apparatus further comprising: a sensing unit that senses the tension of the intermediate transfer body, wherein the control unit controls the adjustment mechanism to adjust the abutment condition based on a sensing result of the sensing unit.

Preferably, the adjustment mechanism is a mechanism that adjusts the abutment condition by changing the tension of the intermediate transfer body, and the control unit controls the adjustment mechanism so that the tension of the intermediate transfer body can be kept substantially constant in a case of adjusting the abutment condition.

Preferably, the adjustment mechanism is a mechanism that adjusts the abutment condition by changing an abutment pressure of the cleaning member against the intermediate transfer body, and the control unit controls the adjustment mechanism to increase the abutment pressure in a case of adjusting the abutment condition.

Preferably, the adjustment mechanism is a mechanism that adjusts the abutment condition by changing an abutment angle of the cleaning member against the intermediate transfer body, and the control unit controls the adjustment mechanism to increase the abutment angle in a case of adjusting the abutment condition.

Preferably, the image forming apparatus further comprising: a cleaning unit to remove the recording materials remaining on the intermediate transfer body, the cleaning unit being provided on a downstream side of the secondary transfer unit in a running direction of the intermediate transfer body and an upstream side of the cleaning member in the running direction of the intermediate transfer body.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 is a cross-sectional view showing an entire configuration of an image forming apparatus in a first embodiment of the present invention;

FIG. 2 is a block diagram showing an electrical configuration of the image forming apparatus in the first embodiment of the present invention;

FIG. 3A is a view showing a configuration of a vicinity of an intermediate transfer belt cleaning unit in the first embodiment of the present invention;

FIG. 3B is a view showing the configuration of the vicinity of the intermediate transfer belt cleaning unit in the first embodiment of the present invention;

FIG. 4A is a view showing a configuration of a periphery of an intermediate transfer belt in a case of forming a color image;

FIG. 4B is a view showing a configuration of the periphery of the intermediate transfer belt in a case of forming a monochrome image;

FIG. 5 is a flowchart showing an example of a procedure of control by a CPU 50 in the first embodiment of the present invention;

FIG. 6 is a view showing a configuration of a vicinity of rollers which support the intermediate transfer belt;

FIG. 7A is a view showing a configuration of a vicinity of an intermediate transfer belt cleaning unit in a second embodiment of the present invention;

FIG. 7B is a view showing the configuration of the vicinity of the intermediate transfer belt cleaning unit in the second embodiment of the present invention;

FIG. 8 is a flowchart showing an example of a procedure of control by a CPU 50 in the second embodiment of the present invention;

FIG. 9A is a view showing a configuration of a vicinity an intermediate transfer belt cleaning unit in a third embodiment of the present invention;

FIG. 9B is a view showing the configuration of the vicinity of the intermediate transfer belt cleaning unit in the third embodiment of the present invention;

FIG. 10 is a flowchart showing an example of a procedure of control by a CPU 50 in the third embodiment of the present invention;

FIG. 11 is a view showing a modification of the embodiment of the present invention;

FIG. 12 is a view showing a modification of the embodiment of the present invention;

FIG. 13A is a view showing an example of a configuration of a periphery of an intermediate transfer belt in an image forming apparatus capable of forming a color image; and

FIG. 13B is a view showing an example of the configuration of the periphery of the intermediate transfer belt in the image forming apparatus capable of forming a color image.

### DESCRIPTION OF THE PREFERRED EMBODIMENTS

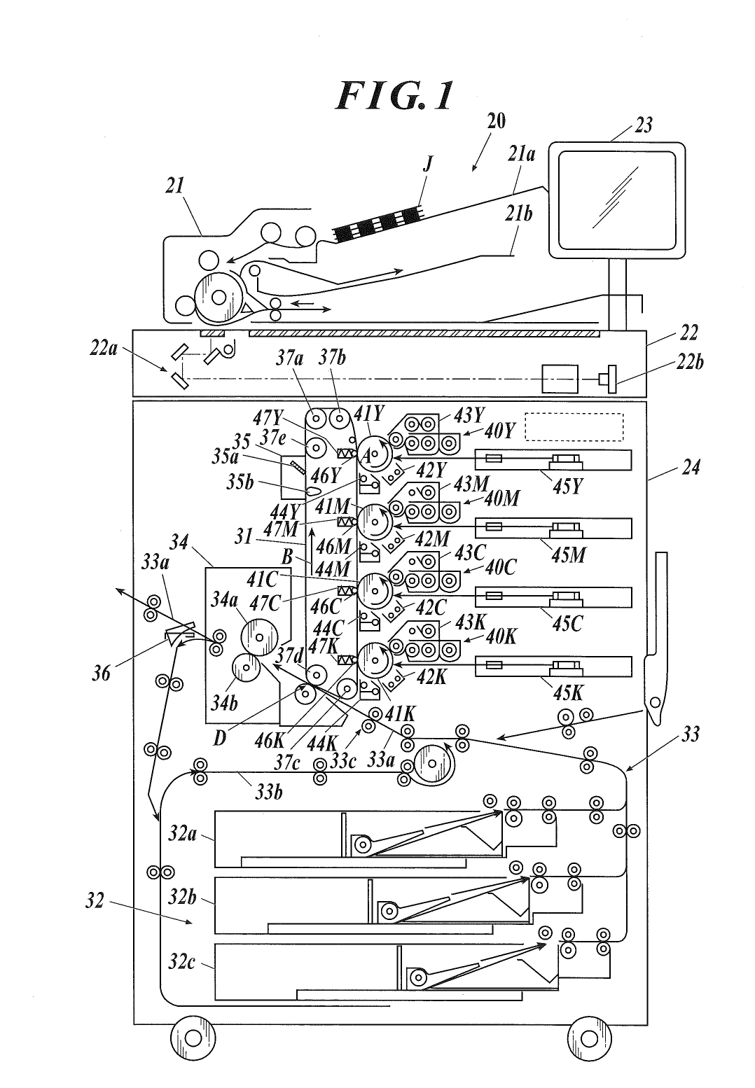

A description is made below of a first embodiment of the present invention while referring to the drawings. FIG. 1 is a cross-sectional view showing an entire configuration of an image forming apparatus in the first embodiment of the present invention. An image forming apparatus 20 shown in FIG. 1 is an image forming apparatus, which is called a tandem type and is capable of forming a full-color image.

The image forming apparatus 20 is composed of a scanner unit 22, a printer unit 24, a sheet feed unit 32, an operation display unit 23 and the like.

The scanner unit 22 is composed of an automatic document feeder (ADF) 21, an optical system 22a, a charge-coupled device (CCD) image sensor 22b and the like.

The printer unit 24 is composed of: image forming units 40Y, 40M, 40C and 40K which form toner images corresponding to the respective colors of yellow, magenta, cyan and black; an intermediate transfer belt 31 as an intermediate transfer body onto which the toner images formed by the respective image forming units are transferred; a secondary transfer unit D that transfers the toner images on the intermediate transfer belt 31 onto sheets; a fixation device 34 that fixes the toner images transferred onto the sheets; and the like.

The sheet feed unit 32 is composed of sheet feed trays 32a to 32c and the like, and appropriate sheets are fed at appropriate timing by the sheet feed unit 32.

The operation display unit 23 includes, for example, a touch panel-type screen, and a user touches icons and the like, which are to be displayed on the screen, and can thereby perform setting regarding contents of image formation, instruction to start the image formation, and the like.

The above is a summary of the respective units of the image forming apparatus 20. Subsequently, while taking as an example the case of forming the full-color image on each of the sheets by the image forming apparatus 20, a description is made of a series of operations for such formation of the full-color image.

When the instruction to start the image formation is made on the operation display unit 23, a document J mounted on a document stage 21a of the automatic document feeder 21 is conveyed to a document reader. Then, reflected light of light irradiated onto the document from a light source (not shown) is read by the CCD image sensor 22b through the optical system 22a.

Various pieces of image processing are implemented for a signal read by the CCD image sensor 22b. Based on the image signal subjected to the image processing, the image forming units 40Y to 40K form the toner images of the respective colors.

The image forming unit 40Y that forms the toner image of the yellow color is composed of: the photosensitive drum 41Y as an image carrier, a charge unit 42Y, an exposure unit 45Y, a development unit 43Y, and a cleaning unit 44Y. In the case of forming the image, the photosensitive drum 41Y is rotated in a direction of an arrow A in FIG. 1 by a drive unit (not shown), and a surface thereof is uniformly charged by the charge unit 42Y. Based on the above-described image signal, the exposure unit 45Y irradiates a laser beam onto the photosensitive drum 41Y thus uniformly charged, and thereby forms an electrostatic latent image corresponding to the image of the yellow color.

Next, by the development unit 43Y, toner of the yellow color, which is a recording material, is fed into the electrostatic latent image on the photosensitive drum 41Y, and the toner image of the yellow color is formed on the photosensitive drum 41Y. The formed toner image is electrostatically transferred onto the intermediate transfer belt 31 by a transfer voltage to be applied to a primary transfer roller 46Y by a voltage applying unit (not shown).

The primary transfer roller 46Y as a primary transfer member is composed so as to be movable by a pressure-contacting/leaving mechanism 47Y to a position of pressure-contacting the photosensitive drum 41Y and a position of being spaced apart therefrom. In the event of forming the image of the yellow color, as shown in FIG. 1, the primary transfer roller 46Y is brought into pressure contact with the photosensitive drum 41Y through the intermediate transfer belt 31.

The toner that remains on the surface of the photosensitive drum 41Y without being completely transferred onto the intermediate transfer belt 31 is removed by the cleaning unit 44Y, and the image forming unit 40Y prepares for the next formation of the toner image.

The image forming unit 40M that forms the toner image of the magenta color, the image forming unit 40C that forms the image of the cyan color, and the image forming unit 40K that forms the image of the black color individually have similar configurations to that of the image forming unit 40Y that forms the image of the yellow color, and accordingly, a detailed description thereof is omitted.

The intermediate transfer belt 31 is an endless belt wound around a plurality of rollers 37a to 37e as support members, and is rotatably supported. In the event of performing the image formation, the intermediate transfer belt 31 is rotated in a direction of an arrow B in FIG. 1 by rotational drive of the driving roller 37a.

In the event of performing the full-color image formation, sequentially from the toner image of the yellow color, the toner images are individually transferred onto the intermediate transfer belt 31 at appropriate timing in the primary transfer rollers 46Y, 46M, 46C and 46K, whereby an appropriate full-color toner image corresponding to an image of the document is formed on the intermediate transfer belt 31.

Meanwhile, the sheets fed by any of the sheet feed trays 32a to 32c are conveyed though a conveying path 33a, and reach a resist roller pair 33c. Conveying-direction skew of the sheets is corrected by the resist roller pair 33c, and each of the sheets is conveyed to the secondary transfer unit D so as to match timing thereof with that of the color toner image on the intermediate transfer belt 31.

In the secondary transfer unit D, the full-color toner image on the intermediate transfer belt 31 is electrostatically transferred onto the sheet.

The sheet onto which the full-color toner image is transferred is conveyed toward the fixation device 34, and the toner image is fixed. Meanwhile, the toners which remain on the intermediate transfer belt 31 without being completely transferred onto the sheet are removed by an intermediate transfer belt cleaning unit 35.

The intermediate transfer belt cleaning unit 35 is composed of the blade-like cleaning member 35a, a tension adjustment roller 35b and the like. The cleaning member 35a is allowed to abut against a position, which is not opposite to any of the rollers 37a to 37e in the intermediate transfer belt 31, at predetermined pressure and angle, which are suitable for the cleaning of the toners.

The above-described predetermined angle and pressure are decided in advance so that a tension of the intermediate transfer belt 31 in a state where all of the primary transfer rollers are in pressure-contact with the respective photosensitive drums can be taken as a reference, and that the cleaning can be performed appropriately based on the tension as the reference.

By the cleaning member 35a, the remaining toners which have adhered onto the intermediate transfer belt 31 are removed like being scraped off.

The tension adjustment roller 35b is a roller for adjusting the tension of the intermediate transfer belt 31. Details of operations of the tension adjustment roller 35b will be described later.

The fixation device 34 is composed of a fixation roller 34a, a pressurizing roller 34b and the like. The fixation roller 34a and the pressurizing roller 34b are individually heated by a heating unit (not shown) so that surfaces thereof can reach a temperature suitable for the fixation of the toner image. Here, a surface temperature of the fixation roller 34a is preset so as to be higher than a surface temperature of the pressurizing roller 34b.

To the sheet onto which the toner image is transferred, the heat and the pressure are applied by the fixation roller 34a and the pressurizing roller 34b, whereby the color toner image is fixed to the sheet.

The sheet to which the color toner image is fixed is conveyed through the conveying path 33a, and is discharged to an outside of the image forming apparatus 20.

In the case of forming images on both surfaces of the sheet, when the toner image is fixed to the surface of the sheet by the fixation device 34, then the sheet is conveyed toward a reversing route 33b by a branch unit 36, and a rearmost end thereof in the conveying direction is reversed. The sheet in which the rearmost end is reversed passes through the reversing route 33b, and is conveyed to the resist roller pair 33c, where the conveying-direction skew thereof is corrected.

Thereafter, as mentioned above, a color toner image corresponding to an image to be formed on a back surface of the sheet is transferred in the secondary transfer unit D, the color toner image on the back surface is fixed by the fixation device 34, and the sheet is discharged to the outside of the image forming apparatus 20.

The above is the description of a series of the operations in the event of forming the color image on the sheet by the image forming apparatus 20. Here, the description has been made of the example of the color mode of forming the color image; however, the image forming apparatus 20 also includes a monochrome mode of forming a monochrome image composed of a single color. For example, by an operation in the operation display unit 23, it can be selected whether to execute the color mode or to execute the monochrome mode.

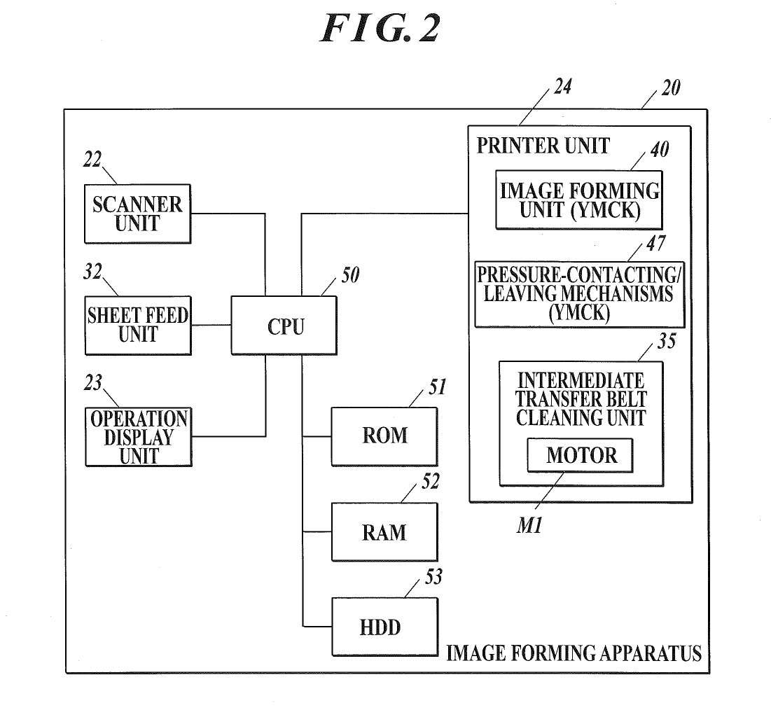

FIG. 2 is a block diagram showing an electrical configuration of the image forming apparatus 20. The same reference numerals as the reference numerals assigned in FIG. 1 are assigned to the same constituents as those in FIG. 1.

The image forming apparatus 20 is composed of the scanner unit 22, the printer unit 24, the sheet feed unit 32, the operation display unit 23, a CPU 50, a ROM 51, a RAM 52, an HDD 53 and the like.

The printer unit 24 is composed of the image forming units 40, the pressure-contacting/leaving mechanisms 47, the intermediate transfer belt cleaning unit 35 and the like, and the intermediate transfer belt cleaning unit 35 includes a motor M1 that rotates the tension adjustment roller 35b as mentioned above.

The CPU 50 as a control unit receives input information from the operation display unit 23, controls the operations of the respective units which are the scanner unit 22, the printer unit 24 and the sheet feed unit 32, and forms an appropriate image, which corresponds to the input information, on the sheet.

In the ROM 51, a variety of programs or data are stored, and the CPU 50 reads out the programs or the data from the ROM 51, and controls the respective units of the image forming apparatus 20.

The RAM 52 is a place that temporarily stores the programs or the data, which are necessary in the event where the CPU 50 controls the operations of the above-described respective units.

The HDD 53 is a place that stores image data. Image data of the document read by the scanner unit 22 is stored in the HDD 53.

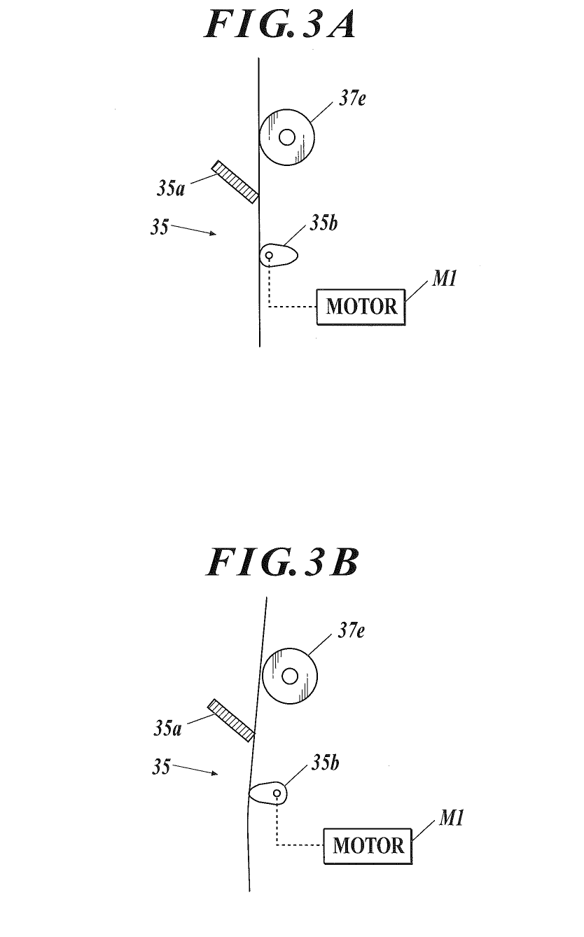

Next, a description is made of a configuration of a periphery of the intermediate transfer belt cleaning unit 35 by using FIGS. 3A and 3B. As shown in FIG. 3A, the tension adjustment roller 35b is provided so as to contact an inner circumferential surface of the intermediate transfer belt 31.

The motor M1 is connected to the egg-shaped tension adjustment roller 35b, and the egg-shaped tension adjustment roller 35b is rotated in a clockwise direction of FIG. 3A by rotational drive of the motor M1. A state shown in FIG. 3A is defined as a home position of the tension adjustment roller 35b.

When the tension adjustment roller 35b is rotated, then as shown in FIG. 3B, the intermediate transfer belt 31 is pushed out to an outside (left side in FIG. 3B) by the tension adjustment roller 35b. In such a way, the tension of the intermediate transfer belt 31 is increased.

As shown in FIGS. 3A and 3B, the motor M1 is driven and the tension adjustment roller 35b is rotated, whereby it is possible to adjust the tension of the intermediate transfer belt 31. In this embodiment, the tension adjustment roller 35b and the motor M1 serve as an adjustment mechanism of the present invention.

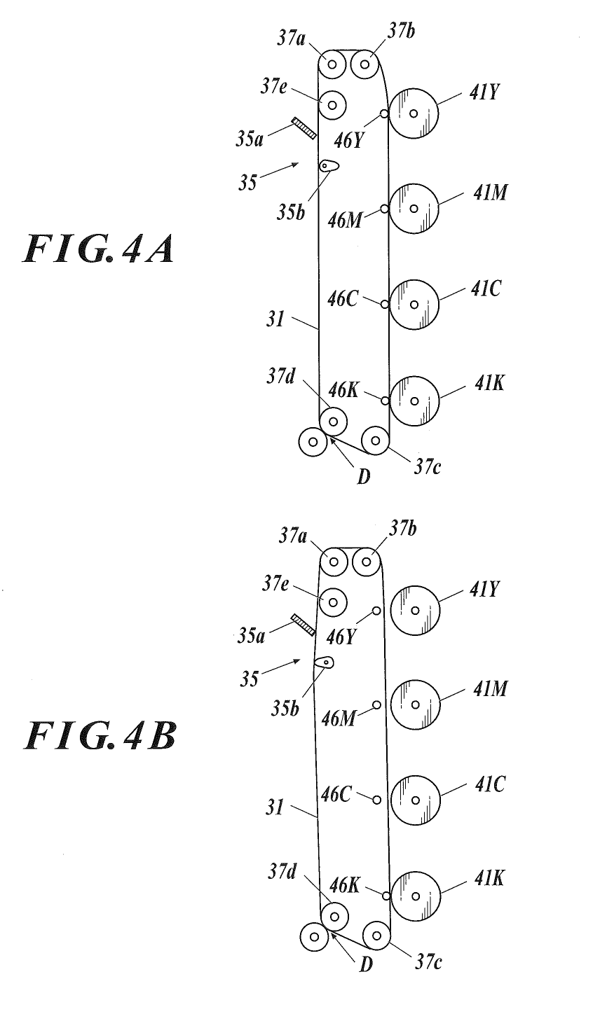

FIGS. 4A and 4B are views briefly showing a configuration of a periphery of the intermediate transfer belt 31. FIG. 4A shows a state when there is executed the color mode of forming the color image on the sheet, and FIG. 4B shows a state where there is executed the monochrome mode of forming the monochrome image as an image composed of a single color on the sheet.

In the case of forming the color image, as shown in FIG. 4A, the primary transfer rollers 46Y to 46K corresponding to the respective colors of yellow, magenta, cyan and black are in a state of being brought into pressure contact with the photosensitive drums 41Y to 41K through the intermediate transfer belt 31.

In this case, the four primary transfer rollers are brought into pressure contact with the respective photosensitive drums, whereby a phenomenon that the intermediate transfer belt 31 is pulled in a right direction (direction toward the photosensitive drum) in FIG. 4A occurs. By this phenomenon, the tension of the intermediate transfer belt 31 is kept high, and accordingly, the remaining toners are appropriately removed by the cleaning member 35a of the intermediate transfer belt cleaning unit 35.

Meanwhile, FIG. 4B shows the case where a black image is formed as the monochrome image. In the case of forming the black image, only a black toner image is formed, and is transferred onto the intermediate transfer belt 31, and accordingly, only the primary transfer roller 46K corresponding to black is in a state of being brought into pressure contact with the photosensitive drum 41K through the intermediate transfer belt 31. The primary transfer rollers 46Y, 46M and 46C corresponding to the colors other than black are in a state of being spaced apart from the photosensitive drums 41.

In this case, in comparison with the case of forming the color image, which is shown in FIG. 4A, force to pull the intermediate transfer belt 31 to the photosensitive drum side is weakened. Hence, in the case of forming the monochrome image, the tension of the intermediate transfer belt 31 will be weakened in comparison with the case of forming the color image.

When the tension of the intermediate transfer belt 31 is weakened, an abutment relationship between the cleaning member 35a and the intermediate transfer belt 31 is changed, whereby there occurs a possibility that the cleaning of the remaining toner by the cleaning member 35 may be insufficient to affect the subsequent image formation.

Accordingly, in this embodiment, in the event of forming the monochrome image on the sheet, the tension adjustment roller 35b is rotated, whereby the tension of the intermediate transfer belt 31 is increased to be kept substantially constant, whereby it is made possible to remove the remaining toner in the intermediate transfer belt cleaning unit 35 without allowing the remaining toner to slip therethrough.

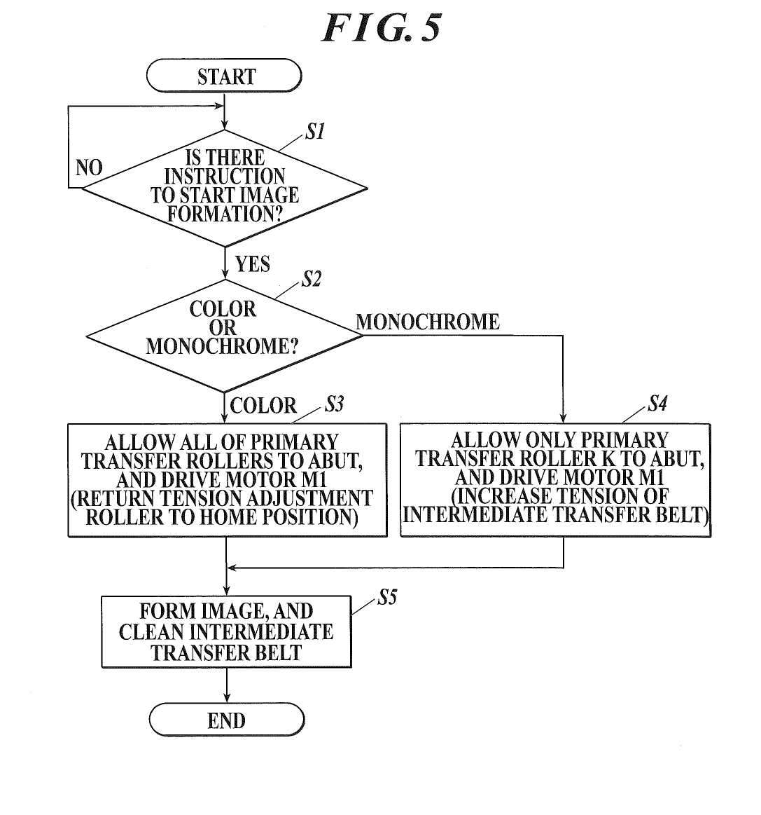

Details of operations in this case are described. FIG. 5 is a flowchart showing an example of a procedure of control by the CPU 50.

First, the CPU 50 determines whether or not the instruction to start the image formation is made on the operation display unit 23 (Step S1). In the case where such an instruction to form the image is not made (Step S1: No), the CPU 50 stays on standby until the instruction to form the image is made.

When the instruction to form the image is made (Step S1: Yes), the CPU 50 refers to whether the image to be formed is a color image or a monochrome image (Step S2).

In the case where the image to be formed is the color image (Step S2: Color), the CPU 50 controls the respective pressure-contacting/leaving mechanisms 47Y to 47K to bring the primary transfer rollers 46Y to 46K into pressure contact with the photosensitive drums 41Y to 41K, respectively. Moreover, the CPU 50 drives the motor M1 so as to rotationally move the tension adjustment roller 35b to the home position shown in FIG. 3A (Step S3). At this time, in the case where the tension adjustment roller 35b is placed at the home position from the beginning, the CPU 50 does not drive the motor M1.

Meanwhile, in the case where the image to be formed on the sheet is the monochrome image (Step S2: Monochrome), the CPU 50 controls the pressure-contacting/leaving mechanisms 47Y to 47K to bring only the primary transfer roller 46K corresponding to black into pressure contact with the photosensitive drum 41K. Moreover, in order to increase the tension of the intermediate transfer belt 31 as mentioned above, the CPU 50 operates the motor M1 for a predetermined time, thereby rotates the tension adjustment roller 35b to the position shown in FIG. 3B, pushes out the intermediate transfer belt 31 to the outside, and increases the tension of the intermediate transfer belt 31 (Step S4).

When the pressure contact of the primary transfer roller(s) with the photosensitive drum(s) (and the drive of the motor M1) is completed, the CPU 50 controls the printer unit 24 to form the color or monochrome toner image by the image forming unit(s), to primarily transfer the formed toner image onto the intermediate transfer belt 31, and further to transfer the toner image onto the sheet in the secondary transfer unit D. Moreover, the CPU 50 allows the sheet, onto which the toner image is transferred, to be conveyed toward the fixation device 34, and allows the toner image to be fixed (Step S5).

Moreover, the toner(s) which remain on the intermediate transfer belt 31 without being completely transferred onto the sheet in the secondary transfer unit D are removed in the intermediate transfer belt cleaning unit 35. At this time, even in the case of forming the color image, or even in the case of forming the monochrome image, the tension of the intermediate transfer belt 31 is kept substantially constant, and accordingly, the remaining toner(s) on the intermediate transfer belt 31 are removed without slipping through the intermediate transfer belt cleaning member 35.

The above is the description of the first embodiment of the present invention. In accordance with this embodiment, in the case of forming the monochrome image, the tension adjustment roller 35b is rotated to increase the tension of the intermediate transfer belt 31, whereby the tension of the intermediate transfer belt 31 is kept substantially constant, and in such a way, it is always possible to completely remove the remaining toner on the intermediate transfer belt 31.

In this embodiment, in the case of forming the monochrome image, the tension adjustment roller 35b is rotated, whereby the tension of the intermediate transfer belt 31 is increased, and the tension of the intermediate transfer belt 31 is kept substantially constant. However, a configuration for keeping the tension of the intermediate transfer belt 31 is not limited to this.

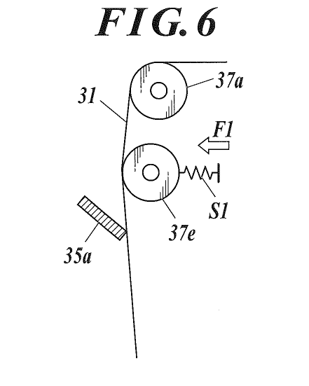

For example, as shown in FIG. 6, in the case of adopting a configuration so that the position of any (roller 37e in FIG. 6) of the plurality of rollers 37a to 37e which support the intermediate transfer belt 31 can be movable, further providing an adjustment member such as a spring S1 for moving the position of the roller concerned, and forming the monochrome image, the present invention is realizable also in such a manner that the position of the roller concerned is moved in the direction of increasing the tension of the intermediate transfer belt 31 by applying predetermined force F1 to the spring S1.

With regard to the force F1 at this time, for example, a configuration just needs to be adopted, in which the tensions of the intermediate transfer belt 31 in the case of forming the color image and the case of forming the monochrome image are individually measured in advance, and based on the measured tensions, the force F1 to be applied for equalizing the tension of the intermediate transfer belt 31 in the case of forming the monochrome image to the tension thereof in the case of forming the color image is calculated, is stored in the ROM 51, and is read out in the event of the above-described control.

Moreover, in this embodiment, while taking as a reference the tension of the intermediate transfer belt 31 in the state where all of the primary transfer rollers are brought into pressure contact with the photosensitive drums, based on the tension concerned, the cleaning member 35a is allowed to abut against the intermediate transfer belt 31 at such angle and pressure at which the cleaning is appropriately performed.

Therefore, in the case where the tension of the intermediate transfer belt 31 is lowered, the tension concerned is increased, whereby the tension of the intermediate transfer belt 31 is kept substantially constant.

However, the tension of the intermediate transfer belt 31, which is taken as the above-described reference, is not limited to the tension in the state where all of the primary transfer rollers are brought into pressure contact with the photosensitive drums.

For example, a configuration may be adopted, in which a tension of the intermediate transfer belt 31 in a state where the primary transfer roller and the photosensitive drum, which correspond to one color, are brought into pressure contact with each other as at the time of executing the monochrome mode is taken as the reference tension, and the cleaning member 35a is allowed to abut against the intermediate transfer belt 31 at such angle and pressure at which the cleaning is appropriately performed in the case of the reference tension concerned.

In this case, the adjustment of the abutment conditions of the cleaning member 35a does not have to be performed at the time of executing the monochrome mode; however, at the time of executing the color mode, the tension of the intermediate transfer belt 31 is increased more than at the time of executing the monochrome mode. Accordingly, it is necessary to keep the tension of the intermediate transfer belt 31 substantially constant by performing the adjustment of the above-described abutment conditions.

In this case, at the time of executing the color mode, the tension of the intermediate transfer belt 31 is adjusted so as to be small, whereby the tension of the intermediate transfer belt 31 can be kept substantially constant. Accordingly, the cleaning is always performed as appropriate, and a good image is formed.

Next, a description is made of a second embodiment of the present invention while referring to the drawings. Note that a detailed description of contents duplicate for those of the first embodiment of the present invention is omitted.

In an image forming apparatus in the second embodiment of the present invention, in the case of forming the monochrome image, the cleaning member 35a increases the pressure to abut against the intermediate transfer belt 31 more than the pressure in the case of forming the color image, whereby it is made possible to remove the remaining toner without allowing the remaining toner concerned to slip through the intermediate transfer belt cleaning unit 35 even in the case where the tension of the intermediate transfer belt 31 is reduced.

The image forming apparatus in this embodiment includes substantially similar configurations to those of the image forming apparatus 20 described in the first embodiment of the present invention, and accordingly, a description of duplicate configurations is omitted.

The image forming apparatus in this embodiment is different from the image forming apparatus 20 in the first embodiment of the present invention in that a configuration for increasing the pressure at which the cleaning member 35a abuts against the intermediate transfer belt 31 is provided in place of the configuration for increasing the tension of the intermediate transfer belt 31, the configuration including the tension adjustment roller 35b shown in FIG. 3 and the movable roller 37e and the spring S1, which are shown in FIG. 6.

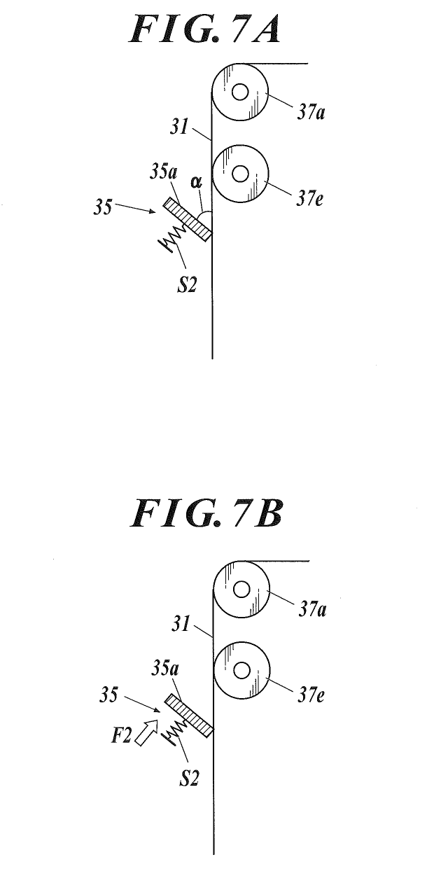

FIGS. 7A and 7B are views showing a configuration of a periphery of the intermediate transfer belt cleaning unit 35 in this embodiment.

As shown in FIG. 7A, by a spring S2, the cleaning member 35a is allowed to abut against the intermediate transfer belt 31 at such predetermined pressure and angle α that enables the cleaning to be performed as appropriate based on the tension of the intermediate transfer belt 31 in the case of forming the color image.

In this embodiment, in the case of forming the monochrome image, predetermined force F2 is further applied to the spring S2 as shown in FIG. 7B, whereby such an abutment pressure of the cleaning member 35a against the intermediate transfer belt 31 is increased more than in the case of forming the color image.

In such a way, even in the case where the tension of the intermediate transfer belt 31 is reduced as in the case of forming the monochrome image, it is made possible to remove the remaining toner on the intermediate transfer belt 31 without allowing the remaining toner concerned to slip through the intermediate transfer belt cleaning unit 35.

In this embodiment, the spring S2 serves as the adjustment mechanism of the present invention.

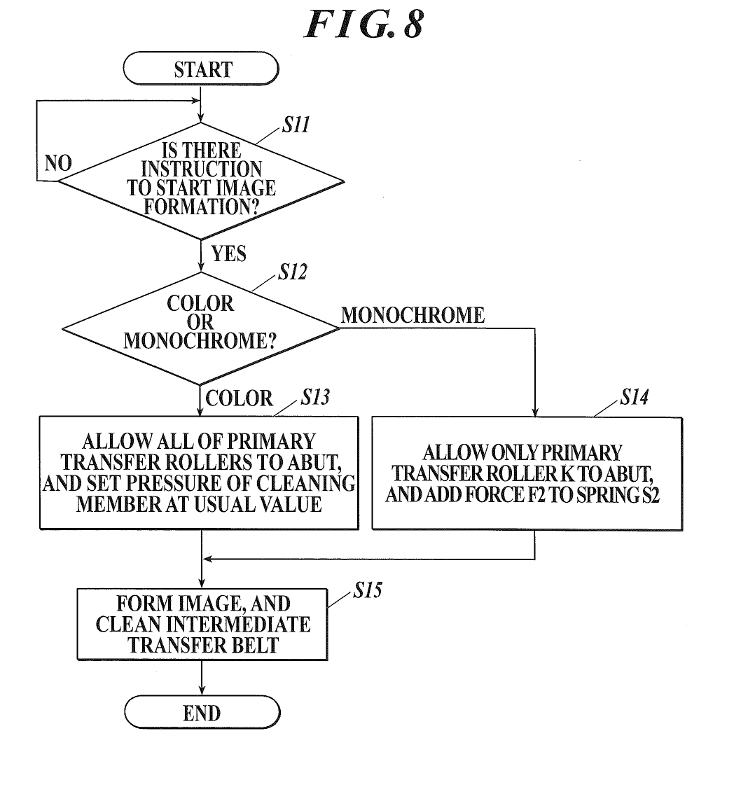

A description is made of details of operations of the image forming apparatus 20 in this embodiment. FIG. 8 is a flowchart showing an example of a procedure of control by the CPU 50.

First, the CPU 50 determines whether or not the instruction to start the image formation is made on the operation display unit 23 (Step S11). In the case where such an instruction to form the image is not made (Step S11: No), the CPU 50 stays on standby until the instruction to form the image is made.

When the instruction to start the image formation is made on the operation display unit 23 (Step S11: Yes), the CPU 50 refers to whether the image to be formed is a color image or a monochrome image (Step S12).

In the case where the image to be formed is the color image (Step S12: Color), the CPU 50 controls the pressure-contacting/leaving mechanisms 47Y to 47K to bring the primary transfer rollers 46Y to 46K into pressure contact with the photosensitive drums 41Y to 41K, respectively. Moreover, the CPU sets the pressure, at which the cleaning member 35a abuts against the intermediate transfer belt 31, at a predetermined value decided in advance (Step S13).

Meanwhile, in the case where the image to be formed on the sheet is the monochrome image (Step S12: Monochrome), the CPU 50 controls the pressure-contacting/leaving mechanisms 47Y to 47K to bring only the primary transfer roller 46K corresponding to black into pressure contact with the photosensitive drum 41K. Moreover, the CPU 50 further applies the force F2 to the spring S2 in order to increase the pressure, at which the cleaning member 35a abuts against the intermediate transfer belt 31, as mentioned above (Step S14).

With regard to the force F2 at this time, for example, a configuration just needs to be adopted, in which the tensions of the intermediate transfer belt 31 in the case of forming the color image and the case of forming the monochrome image are individually measured in advance, and based on the measured tensions, the force F2 to be applied to the spring S2 for enabling the cleaning to be performed as appropriate by the cleaning member 35a is calculated, is stored in the ROM 51 in advance, and is read out in the event of this control.

When the pressure contact of the primary transfer roller with the photosensitive drum (that is, an increase of urging force of the spring S2) is completed, the CPU 50 controls the printer unit 24 to form the toner image by the image forming unit, to primarily transfer the formed toner image onto the intermediate transfer belt 31, and further to transfer the toner image onto the sheet in the secondary transfer unit D. Moreover, the CPU 50 allows the sheet, onto which the toner image is transferred, to be conveyed toward the fixation device 34, and allows the toner image to be fixed (Step S15).

Moreover, the toner that remains on the intermediate transfer belt 31 without being completely transferred onto the sheet in the secondary transfer unit D is removed in the intermediate transfer belt cleaning unit 35. At this time, even in the case of forming the monochrome image, the abutment pressure of the cleaning member 35a is increased, and accordingly, the remaining toner on the intermediate transfer belt 31 is removed without slipping through the intermediate transfer belt cleaning unit 35.

The above is the description of the second embodiment of the present invention.

Next, a description is made of a third embodiment of the present invention while referring to the drawings. Note that a detailed description of contents duplicate for those of the first and second embodiments of the present invention is omitted.

In the image forming apparatus in the third embodiment of the present invention, in the case of forming the monochrome image, an abutment angle of the cleaning member 35 against the intermediate transfer belt 31 is changed from an angle thereof in the case of forming the color image, whereby it is made possible to remove the remaining toner without allowing the remaining toner concerned to slip through the intermediate transfer belt cleaning unit 35 even in the case where the tension of the intermediate transfer belt 31 is reduced.

The image forming apparatus in this embodiment includes substantially similar configurations to those of the image forming apparatuses 20 described in the first and second embodiments of the present invention, and accordingly, a description of duplicate configurations is omitted.

The image forming apparatus in this embodiment is different from the image forming apparatuses 20 in the first and second embodiments of the present invention in that a configuration for increasing the abutment angle of the cleaning member 35a against the intermediate transfer belt 31 is provided in place of the configuration for increasing the tension of the intermediate transfer belt 31 in the first embodiment and the configuration for increasing the abutment pressure of the cleaning member 35a in the second embodiment.

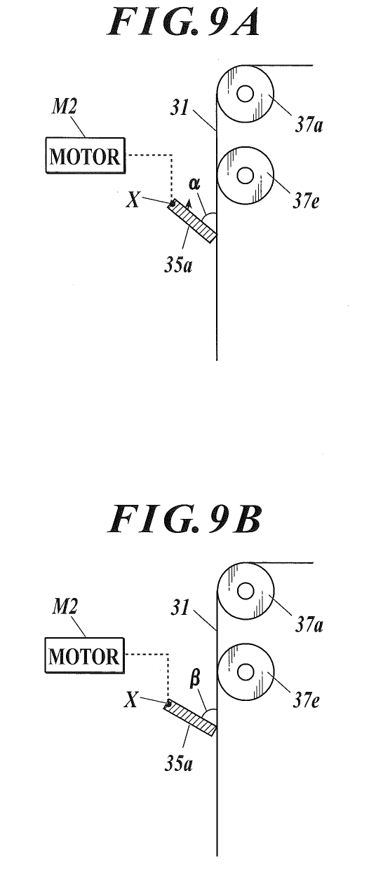

FIGS. 9A and 9B are views showing a configuration of a peilphery of the intermediate transfer belt cleaning unit 35 in this embodiment.

As shown in FIG. 9A, the cleaning member 35a is allowed to abut against the intermediate transfer belt 31 at such predetermined pressure and angle α that enables the cleaning to be performed as appropriate based on the tension of the intermediate transfer belt 31 in the case of forming the color image.

The cleaning member 35a is supported so as to be rotatable by a shaft X in an arrow direction of FIG. 9A. A motor M2 is connected to the shaft X, and the motor M2 is driven, the cleaning member 35a is rotated in the arrow direction together with the shaft X. In this embodiment, the motor M2 serves as the adjustment mechanism of the present invention.

In this embodiment, in the case of forming the monochrome image, as shown in FIG. 9B, the motor M2 is driven for a predetermined time to rotate the cleaning member 35a so that an angle made by the cleaning member 35a and the intermediate transfer belt 31 can be β(α<β).

In such a way, even in the case where the tension of the intermediate transfer belt 31 is reduced as in the case of forming the monochrome image, it is made possible to remove the remaining toner on the intermediate transfer belt 31 without allowing the remaining toner concerned to slip through the intermediate transfer belt cleaning unit 35.

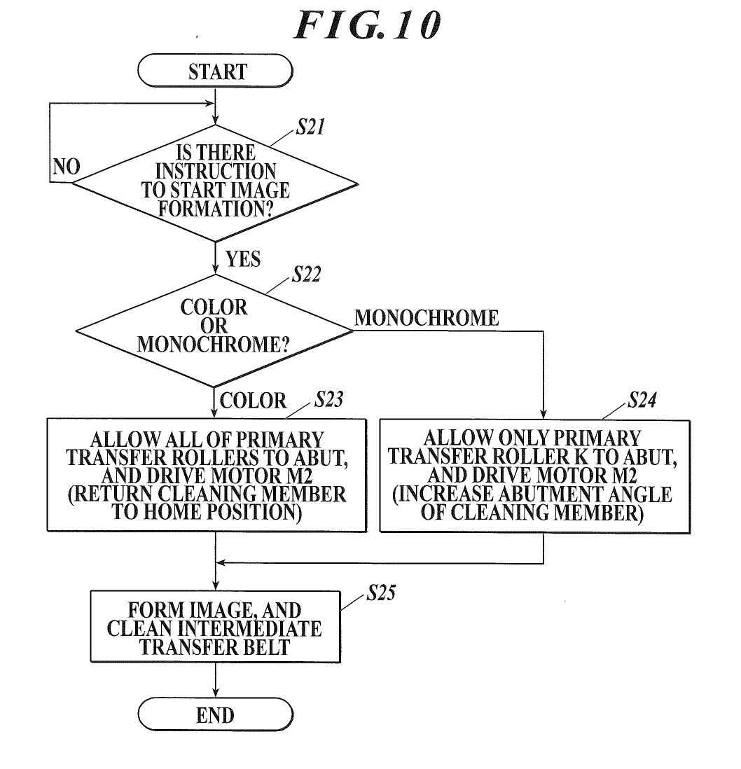

A description is made of details of operations of the image forming apparatus 20 in this embodiment. FIG. 10 is a flowchart showing an example of a procedure of control by the CPU 50.

First, the CPU 50 determines whether or not the instruction to start the image formation is made on the operation display unit 23 (Step S21). In the case where such an instruction to form the image is not made (Step S21: No), the CPU 50 stays on standby until the instruction to form the image is made.

When the instruction to start the image formation is made on the operation display unit 23 (Step S21: Yes), the CPU 50 refers to whether the image to be formed is a color image or a monochrome image (Step S22).

In the case where the image to be formed is the color image (Step S22: Color), the CPU 50 controls the pressure-contacting/leaving mechanisms 47Y to 47K to bring the primary transfer rollers 46Y to 46K into pressure contact with the photosensitive drums 41Y to 41K, respectively. Moreover, the CPU 50 drives the motor M2 so that the cleaning member 35a can be located at the home position where the abutment angle against the intermediate transfer belt 31 becomes the angle α decided in advance (Step S23). At this time, in the case where the cleaning member 35a is located at the home position from the beginning, the CPU 50 does not drive the motor M2.

Meanwhile, in the case where the image to be formed on the sheet is the monochrome image (Step S22: Monochrome), the CPU 50 controls the pressure-contacting/leaving mechanisms 47Y to 47K to bring only the primary transfer roller 46K corresponding to black into pressure contact with the photosensitive drum 41K. Moreover, as mentioned above, the CPU 50 drives the motor M2 so that the abutment angle of the cleaning member 35a against the intermediate transfer belt 31 can be changed from the angle in the case of forming the color image, and that the angle made by the cleaning member 35a and the intermediate transfer belt 31 can become β (Step S24).

With regard to the angle β at this time, for example, a configuration just needs to be adopted, in which the tensions of the intermediate transfer belt 31 in the case of forming the color image and the case of forming the monochrome image are individually measured in advance, and based on the measured tensions, the abutment angle β of the cleaning member 35a, which enables the cleaning to be performed as appropriate by the cleaning member 35a in the case of forming the monochrome image, is calculated, is stored in the ROM 51 in advance, and is read out in the event of this control.

When the pressure contact of the primary transfer roller with the photosensitive drum (and the change of the abutment angle of the cleaning member 35a) is completed, the CPU 50 controls the printer unit 24 to form the toner image by the image forming unit, to primarily transfer the formed toner image onto the intermediate transfer belt 31, and further to transfer the toner image onto the sheet in the secondary transfer unit D. Moreover, the CPU 50 allows the sheet, onto which the toner image is transferred, to be conveyed toward the fixation device 34, and allows the toner image to be fixed (Step S25).

Moreover, the toner that remains on the intermediate transfer belt 31 without being completely transferred onto the sheet in the secondary transfer unit D is removed in the intermediate transfer belt cleaning unit 35. At this time, even in the case of forming the monochrome image, the angle made by the cleaning member 35a and the intermediate transfer belt 31 is increased, and accordingly, the remaining toner on the intermediate transfer belt 31 is removed without slipping through the intermediate transfer belt cleaning unit 35.

The above is the description of the third embodiment of the present invention.

As described above, in the first to third embodiments of the present invention, in the case of forming the monochrome image, the tension of the intermediate transfer belt 31, the abutment pressure of the cleaning member 35a or the abutment angle of the cleaning member 35a is adjusted based on the value decided for each thereof in advance.

However, the tension of the intermediate transfer belt 31 in the case of forming the monochrome image does not always become constant owing to factors such as changes with passage of time of various members. Moreover, because of similar reasons, even in the case of forming the color image, the tension of the intermediate transfer belt 31 is changed in some case.

In these cases, preferably, not the adjustment that is based on such an adjustment value decided in advance as described above, but adjustment of the cleaning member 35a or the intermediate transfer belt 31, which is based on an actual tension of the intermediate transfer belt 31, is performed.

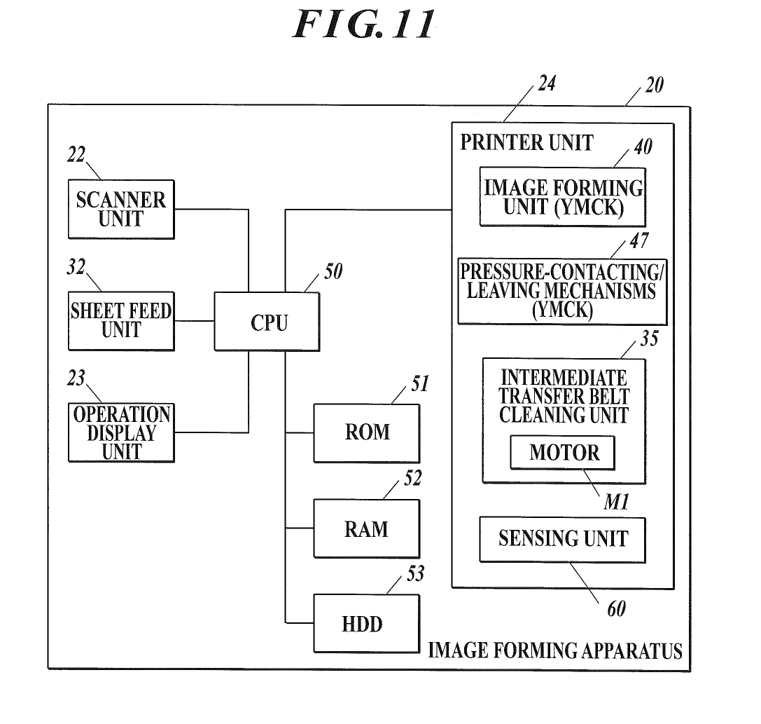

For example, as shown in FIG. 11, the present invention is realizable also in such a manner that a sensor 60 as a sensing unit that senses the tension of the intermediate transfer belt 31 is provided, and based on the tension sensed by the sensor concerned, the tension of the intermediate transfer belt 31, the abutment pressure of the cleaning member 35a or the abutment angle of the cleaning member 35a is adjusted.

The adjustment is performed as described above based on the actual tension of the intermediate transfer belt 31, whereby the change of the tension of the intermediate transfer belt 31 owing to the above-mentioned change with passage of time, and the like can also be coped with, and it is made possible to perform good image formation more surely.

Moreover, a configuration may also be adopted, in which it is made possible to perform the above-described adjustment as appropriate by operating the operation display unit 23 and the like, for example, in such a case where lowering of image quality is recognized as a result that the user visually confirms the image formed by the image forming apparatus 20.

Furthermore, in each of the above-described embodiments, the case of forming the black image is described as an example of executing the monochrome mode of forming the image composed of a single color; however, it is needless to say that the present invention is also applicable to the case of forming an image composed of only a color other than the black color.

Moreover, in this embodiment, the description is made of the example of taking as a reference the determination result as to whether the case is the case of executing the color mode or the case of executing the monochrome mode and adjusting the abutment condition between the intermediate transfer belt 31 and the cleaning member 35a; however, the CPU 50 may determine whether or not to perform the adjustment under the above-described abutment condition in response to the number of photosensitive drums and to the number of primary transfer rollers to be spaced apart therefrom.

Specifically, in the case where the primary transfer rollers and the photosensitive drums, which correspond to one or more colors, are spaced apart from each other, the tension of the intermediate transfer belt 31 is lowered, and accordingly, the CPU 50 just needs to perform control so as to adjust the abutment condition between the intermediate transfer belt 31 and the cleaning member 35a.

Moreover, the CPU 50 may decide contents of the adjustment of the above-described abutment condition in response to the number of photosensitive drums and to the number of primary transfer rollers to be spaced therefrom.

Specifically, for example, in the case of forming an image composed of two colors, a state is brought, where the primary transfer rollers and the photosensitive drums, which correspond to the two colors concerned, are brought into pressure contact with each other, and the primary transfer rollers and the photosensitive drums, which correspond to other two colors, are spaced apart from each other.

In this case, in comparison with the above-mentioned time of executing the monochrome mode, a lowering amount of the tension of the intermediate transfer belt 31 is reduced. Hence, when the first embodiment is taken as an example, such an increasing amount of the tension, which is necessary to keep the tension of the intermediate transfer belt 31 substantially constant, is also reduced in a similar way.

In a similar way, in the case of forming an image composed of three colors, a state is brought where only the primary transfer roller and the photosensitive drum, which correspond to one color, are spaced apart from each other, and accordingly, the increasing amount of the tension, which is necessary to keep the tension of the intermediate transfer belt 31 substantially constant, is further reduced.

Based on such an idea as described above, if the CPU 50 performs control to decide an adjustment amount of the tension so that appropriate abutment conditions can be established in response to the number of photosensitive drums and to the number of primary transfer rollers to be spaced apart therefrom, then the good cleaning is always performed by the cleaning member 35a, and this is more preferable.

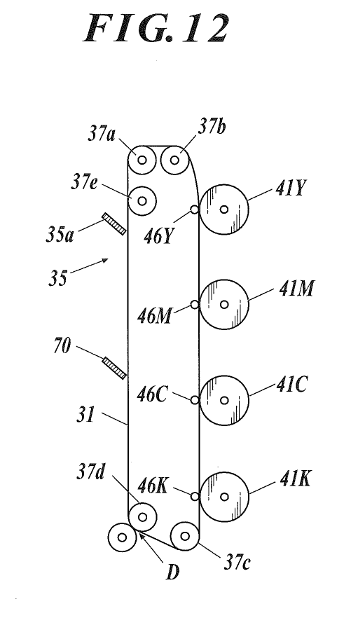

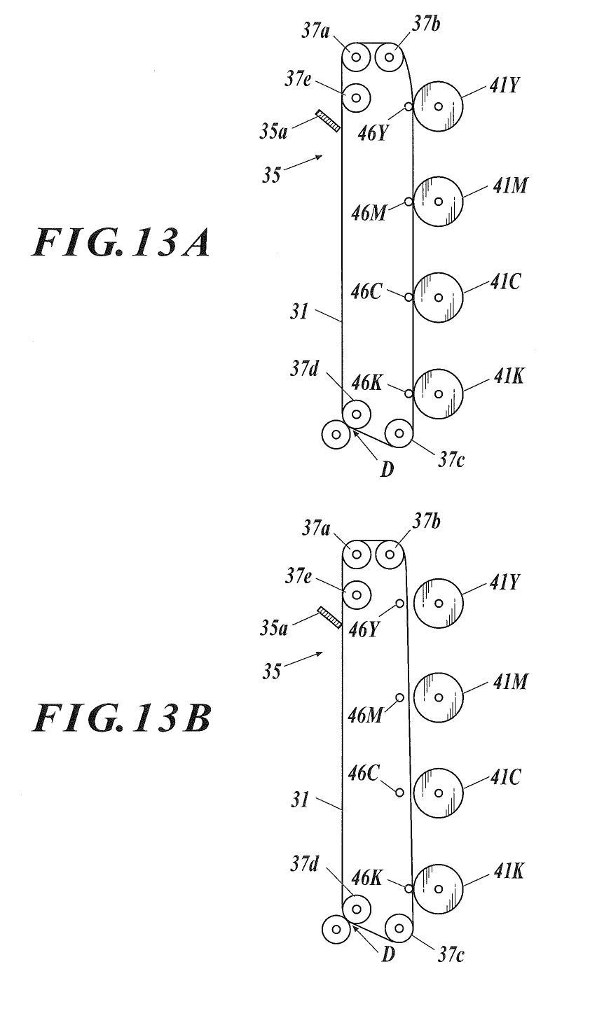

Moreover, as shown in FIG. 12, on a downstream side of the secondary transfer unit D in a running direction of the intermediate transfer belt 31 and an upstream side of the cleaning member 35a in the running direction of the intermediate transfer belt 31, a cleaning unit 70 that removes the toner remaining on the intermediate transfer belt 31 may be provided separately from the cleaning member 35a. In such a way, further enhancement of cleaning performance for the intermediate transfer belt 31 is expected.

Besides, the present invention is not limited to the above-described embodiments, and it is also possible to adopt different embodiments within the scope without departing from the present invention.

The entire disclosure of Japanese Patent Application No. 2011-221505 filed on Oct. 6, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image forming apparatus comprising:
a plurality of image carriers on which images are to be individually formed by recording materials;
an intermediate transfer body onto which the images formed on the plurality of image carriers are to be transferred;
a plurality of primary transfer members which individually transfer the images formed on the plurality of image carriers onto the intermediate transfer body;
a plurality of support members that rotatably support the intermediate transfer body;
a secondary transfer unit that further transfers the images transferred onto the intermediate transfer body onto a transfer material;
a cleaning member that abuts against the intermediate transfer body at a position other than a position opposite to the support member under a predetermined condition based on a reference tension of the intermediate transfer body, and removes the recording materials remaining on the intermediate transfer body without being transferred onto the transfer material in the secondary transfer unit;
an adjustment mechanism capable of adjusting an abutment condition between the cleaning member and the intermediate transfer body; and
a control unit that controls the adjustment mechanism to adjust the abutment condition between the cleaning member and the intermediate transfer body to become a condition suitable for removing the recording materials by the cleaning member in a case where a tension of the intermediate transfer body is changed from the reference tension of the intermediate transfer body.

2. The image forming apparatus according to claim 1, further comprising:
pressure-contacting/leaving mechanisms which individually bring the plurality of primary transfer members into pressure contact with the plurality of image carriers and individually space the plurality of primary transfer members apart from the plurality of image carriers,
wherein the control unit controls the pressure-contacting/leaving mechanisms to space the image carrier on which the image is not to be formed and the transfer member apart from each other, and controls the adjustment mechanism to adjust the abutment condition in a case where one or more of the image carriers and one or more of the transfer members are spaced apart from each other.

3. The image forming apparatus according to claim 1, further comprising:
a color mode of forming a color image by forming images of colors different from one another on the plurality of image carriers by the recording materials of colors different from one another, and by superimposing the images of the colors different from one another on one another;
a monochrome mode of forming a monochrome image as an image composed of a single color by the recording material of the single color on any one of the plurality of image carriers; and
pressure-contacting/leaving mechanisms which individually bring the plurality of transfer members into pressure contact with the plurality of image carriers and individually space the plurality of transfer members apart from the plurality of image carriers,
wherein the control unit controls the pressure-contacting/leaving mechanisms to space the image carrier on which the image is not to be formed and the transfer member apart from each other, and controls the adjustment mechanism to adjust the abutment condition in a case of executing the monochrome mode.

4. The image forming apparatus according to claim 3, wherein the single color is black.

5. The image forming apparatus according to claim 1, further comprising:
a sensing unit that senses the tension of the intermediate transfer body,
wherein the control unit controls the adjustment mechanism to adjust the abutment condition based on a sensing result of the sensing unit.

6. The image forming apparatus according to claim 1,
wherein the adjustment mechanism is a mechanism that adjusts the abutment condition by changing the tension of the intermediate transfer body, and
the control unit controls the adjustment mechanism so that the tension of the intermediate transfer body can be kept substantially constant in a case of adjusting the abutment condition.

7. The image forming apparatus according to claim 1,
wherein the adjustment mechanism is a mechanism that adjusts the abutment condition by changing an abutment pressure of the cleaning member against the intermediate transfer body, and
the control unit controls the adjustment mechanism to increase the abutment pressure in a case of adjusting the abutment condition.

8. The image forming apparatus according to claim 1,
wherein the adjustment mechanism is a mechanism that adjusts the abutment condition by changing an abutment angle of the cleaning member against the intermediate transfer body, and
the control unit controls the adjustment mechanism to increase the abutment angle in a case of adjusting the abutment condition.

9. The image forming apparatus according to claim 1, further comprising:
a cleaning unit to remove the recording materials remaining on the intermediate transfer body, the cleaning unit being provided on a downstream side of the secondary transfer unit in a running direction of the intermediate transfer body and an upstream side of the cleaning member in the running direction of the intermediate transfer body.
